(19) United States
(12) Patent Application Publication
(10) Pub. No.: US 2011/0151054 A1
(43) Pub. Date: Jun. 23, 2011

(54) Reduced Sodium Natural Cheese And Method Of Manufacturing

(76) Inventor: John Kieran Brody, Plymouth, WI (US)

(21) Appl. No.: 12/785,030

(22) Filed: May 21, 2010

Related U.S. Application Data
(60) Provisional application No. 61/289,587, filed on Dec. 23, 2009.

(51) Int. Cl. A23C 19/072; A23C 19/06; A23C 19/00

(52) U.S. Cl. 426/38; 426/582

(57) ABSTRACT

A reduced sodium natural cheese product and a method of manufacturing a reduced sodium natural cheese product having a mixture of raw milk, fermentation cultures, and a quantity of curdling agent. The reduced sodium natural cheese product has a predetermined amount of sodium chloride and a reduced moisture content, wherein the reduced sodium natural cheese product has a sodium chloride-to-moisture ratio that is at least about twenty percent less than the sodium chloride-to-moisture ratio of a corresponding conventional natural cheese. The process of manufacturing a reduced sodium natural cheese product includes controlling the salt-to-moisture contents ratio to maintain the highest possible salt-to-moisture ratio in a reduced sodium cheese by deliberately reducing the moisture content in the finished cheese.

### CROSS-REFERENCE TO RELATED APPLICATIONS

This application claims priority benefit of provisional application Ser. No. 61/289,587 filed Dec. 23, 2009, which is incorporated herein by reference in its entirety.

### BACKGROUND OF THE INVENTION

### Field of the Invention

The present invention relates generally to food products, and particularly to a method for making a natural cheese product and a natural cheese product having a reduced sodium content and more particularly having a sodium-to-moisture content ratio within a specified range.

Salt (sodium chloride) plays a major role in the manufacture of cheese. It causes moisture expulsion from cheese curd, it controls bacterial activity, and it provides taste and enhances flavor in the final cheese product. When the amount of salt added to cheese curd during the cheese making process is reduced, the resultant cheese suffers from being high in moisture content, having a lowered degree of bacterial control, and tasting bland. The cheese also has a reduced shelf life due to the higher moisture content and the lowered bacterial control.

In the past, the removal of sodium from cheese was achieved by reducing the amount of salt (sodium chloride) that was added to the cheese curd during manufacture. Depending upon the reduction in the amount of salt that was added, the resulting cheese thus was characterized by the aforementioned problems, namely higher moisture level, bland flavor, and reduced shelf life.

Prior attempts to reduce the salt content in cheese products, other than not adding as much salt, include using ultra-filtration of the milk at the beginning of the process, addition of soluble proteins, or adding potassium salts. Potassium salts are used as a salt substitute in reduced sodium products, but such salts contribute to off-flavors in the cheese products. Such methods typically do not result in commercially acceptable cheese products.

### SUMMARY OF THE INVENTION

The disadvantages and limitations of the background art discussed above are overcome by the present disclosure.

This disclosure described a method for manufacturing a natural cheese having at least twenty-five percent less sodium chloride than a corresponding conventional natural cheese having a conventional moisture content, a conventional sodium chloride content, and a conventional sodium chloride-to-moisture ratio. The method includes establishing a cheese milk from a quantity of milk that is prepared for the manufacture of cheese by adding a quantity of fermentation cultures. The method further includes adding rennet to the cheese milk as well as adding a reduced amount of sodium chloride to the resultant cheese curd mixture.

The method also includes processing the cheese curd mixture to produce a natural cheese product while simultaneously reducing the moisture content of the cheese curd mixture such that the natural cheese product has a sodium chloride content that is no more than about seventy-five percent of the sodium chloride content of a corresponding conventional natural cheese and such that the natural cheese produce has a sodium chloride-to-moisture ratio that is at least about twenty percent less than the sodium chloride-to-moisture ratio of a corresponding conventional natural cheese. The moisture content of the cheese curd is reduced by at least one of a group of procedures consisting of: reducing the cheese curd particle size; increasing the cook temperature of the cheese curd; increasing the stir-out time after cooking the cheese curd mixture; increasing the rate of acid production; separating the cheese curd from whey at a higher acidity level; increasing the rate of dry stirring of the cheese curd prior to the addition of sodium chloride; and any combination of two or more of these procedures. The process produces a reduced sodium natural cheese. The raw milk may be pasteurized before combining with the fermentation cultures and adding the rennet. The process may also include the step of performing pasta filata. The process may also include the step of cheddaring the cheese curd mixture.

There is also provided a method of manufacturing a reduced sodium natural cheese including combining, as a cheese milk mixture, a quantity of cheese milk and cheese starter cultures. Adding rennet to the cheese milk mixture and adding a reduced amount of sodium chloride to the cheese curd mixture. The method further includes reducing the moisture content of the cheese curd below a selected level to produce a natural cheese product having a sodium chloride-to-moisture ratio that is at least about twenty percent less than the sodium chloride-to-moisture ratio of a corresponding conventional natural cheese by one or more processes selected from the group consisting of: reducing the cheese curd particle size; increasing the cook temperature of the cheese curd; increasing the stir-out time after cooking the cheese curd mixture; increasing the rate of acid production; separating the cheese curd from whey at a higher acidity level; and increasing the rate of dry stirring of the cheese curd.

There is further provided a reduced sodium natural cheese product including a mixture of cheese milk and cheese starter cultures. The reduced sodium natural cheese product also includes a quantity of rennet and a predetermined amount of sodium chloride and a reduced moisture content. The reduced sodium natural cheese product has a sodium chloride-to-moisture ratio that is at least about twenty percent less than the sodium chloride-to-moisture ratio of a corresponding conventional natural cheese. In another embodiment the reduced sodium natural cheese product have a moisture content that is at least about two percent less than the moisture content of a corresponding conventional natural cheese. The reduced sodium natural cheese product can be cheddared or subject to a pasta filata procedure and aged for a predetermined time period resulting in one of a Cheddar Cheese, a Colby Cheese, a Colby Jack Cheese, a Monterey Jack Cheese, a Pepper Jack Cheese, an Asadero Cheese, or a Queso Quesadilla Cheese.

### DESCRIPTION OF THE DRAWINGS

These and other advantages of the present disclosure are best understood with reference to the drawings, in which:

FIG. 1 is a schematic illustration of a process for making a reduced sodium natural Cheddar Cheese;

FIG. 2 is a schematic illustration of a process for making a reduced sodium natural Colby-Jack Cheese;

FIG. 3 is a schematic illustration of a process for making a reduced sodium natural Mozzarella, a Provolone Cheese, and String Cheese; and

FIG. 4 is a chart showing the moisture content, the sodium chloride content, and the sodium chloride-to-moisture ratio for nine conventional natural cheeses as compared to nine reduced sodium natural cheeses produced according to the teachings of the present disclosure.

### DETAILED DESCRIPTION OF THE PREFERRED EMBODIMENT

In the conventional manufacture of cheese, milk is processed to produce a semi-solid mass called cheese curd. During the milk processing a liquid is also formed called whey. During the manufacturing process of the cheese, the cheese curd is separated from the whey by several processes that will be explained below. Although salt (sodium chloride)is an important ingredient in natural cheese, a reduced salt natural cheese is beneficial and market enhancing.

Applicant has discovered that by controlling the salt to moisture ratio it is possible to maintain the highest possible salt to moisture ratio in a reduced sodium cheese by deliberately reducing the moisture content in the finished cheese. By reducing the level of moisture content from a conventional moisture range, wherein the reduced sodium natural cheese product has a sodium chloride-to-moisture ratio that is at least about twenty percent less than the sodium chloride-to-moisture ratio of a corresponding conventional natural cheese, it is possible to reduce the amount of sodium chloride added to the cheese curd. Such reduction of sodium chloride and reduced moisture allows obtaining the highest possible sodium chloride-to-moisture ratio whereby the produced natural cheese product does not suffer from a bland flavor or reduced shelf life as typically occurs when the sodium chloride content is reduced without an appropriate reduction of the moisture content of the finished cheese. In accord with this method and process of this disclosure, the salt-to-moisture ratio target of a selected cheese is close to, but less than, the salt-to-moisture ratio of a conventional cheese of the same type.

In prior art processes, some reduced sodium cheeses rely on procedures that include ultra-filtration or reversed osmosis which add additional cost and steps in the cheese making process. The present disclosure does not utilize or require ultra-filtered milk nor rely on a reverse osmosis process. Other prior art methods of producing a low sodium cheese relies on the addition of soluble proteins. As will be discussed below, the present disclosure utilizes only insoluble proteins such as casein. Soluble proteins need not be used in the natural cheese manufacturing disclosed herein.

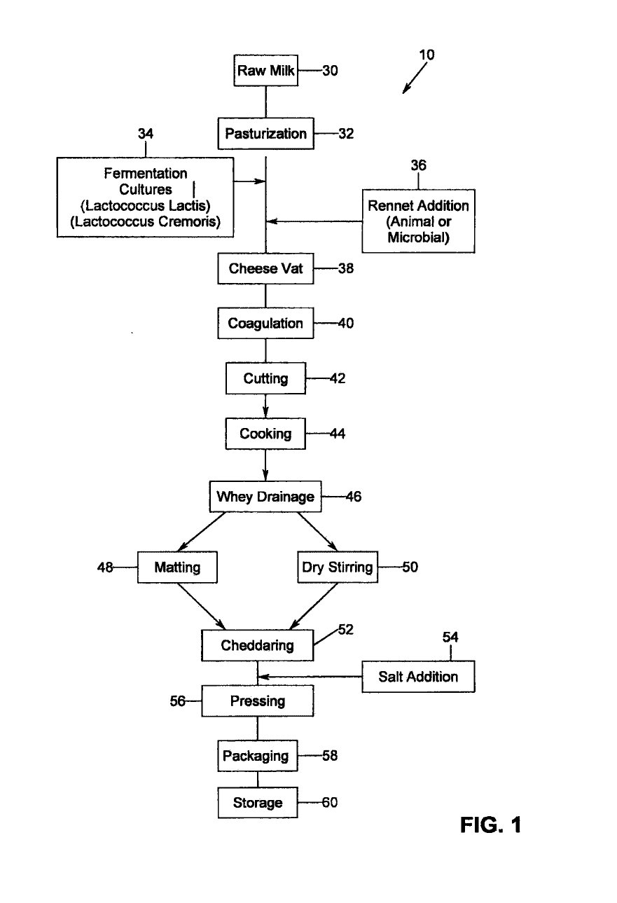

Referring now to the Figures, FIG. 1 illustrates a schematic chart 10 of an exemplary embodiment for making a reduced sodium natural Cheddar Cheese. The illustrated process in FIG. 1 is also used for making an Asadero Cheese and a Queso Quesadilla Cheese as would be understood by one ordinarily skilled in the art of making cheese but for the reduced sodium procedures described herein.

As illustrated in FIG. 1, raw milk 30 is pasteurized, for example by subjecting the raw milk to high heat in a pasteurizer apparatus raising the temperature of the raw milk to approximately 162-165 degrees Fahrenheit for an appropriate amount of time to comply with applicable food standards. Pasteurization 32 is accomplished in a pasteurizer in a plate heat exchanger where steam or hot water flows on one side of a stainless steel plate and the raw milk 30 flows on the other side. The steam/hot water does not mix with the milk. In a preferred embodiment the raw milk 30 is pumped from a milk silo to a pasteurizer apparatus. In the pasteurizer the temperature of the raw milk is raised to 163 degrees Fahrenheit, held for 15 seconds and then cooled to approximately 90 degrees Fahrenheit.

Fermentation cultures 34, also referred to as cheese starter cultures, such as, for example, lactococcus lactis subsp. lactis or lactococcus lactis subsp. cremoris or streptococcus thermophilus is added to the pasteurized milk in a conventional cheese vat 38. After the fermentation cultures 34 are added to the pasteurized milk, a curdling agent, such as rennet (hereinafter referred to as rennet), is added to the mixture. The rennet addition 36 can be of animal or microbial origin. Color additives, such as color Annatto 62, and flavoring additives can also be added to the mixture. If color Annatto 62 is added to the cheese mixture, the resulting Cheddar Cheese 10 will be yellow in color. If the color Annatto 62 is not added, the resulting Cheddar Cheese will be white.

The mixture of pasteurized milk, fermentation cultures 34 and the rennet 36 are contained within a conventional cheese vat 38 sized to contain the volume of mixture to be converted to cheese.

The mixture of milk, fermentation cultures 34 and rennet 36 are allowed to coagulate 40 in the cheese vat 38 for a selected period of time as determined by the cheese maker with the temperature of the mixture maintained at a predetermined temperature, for example 90 degrees Fahrenheit. During the coagulation 40 of the milk mixture the cheese curd and whey are formed.

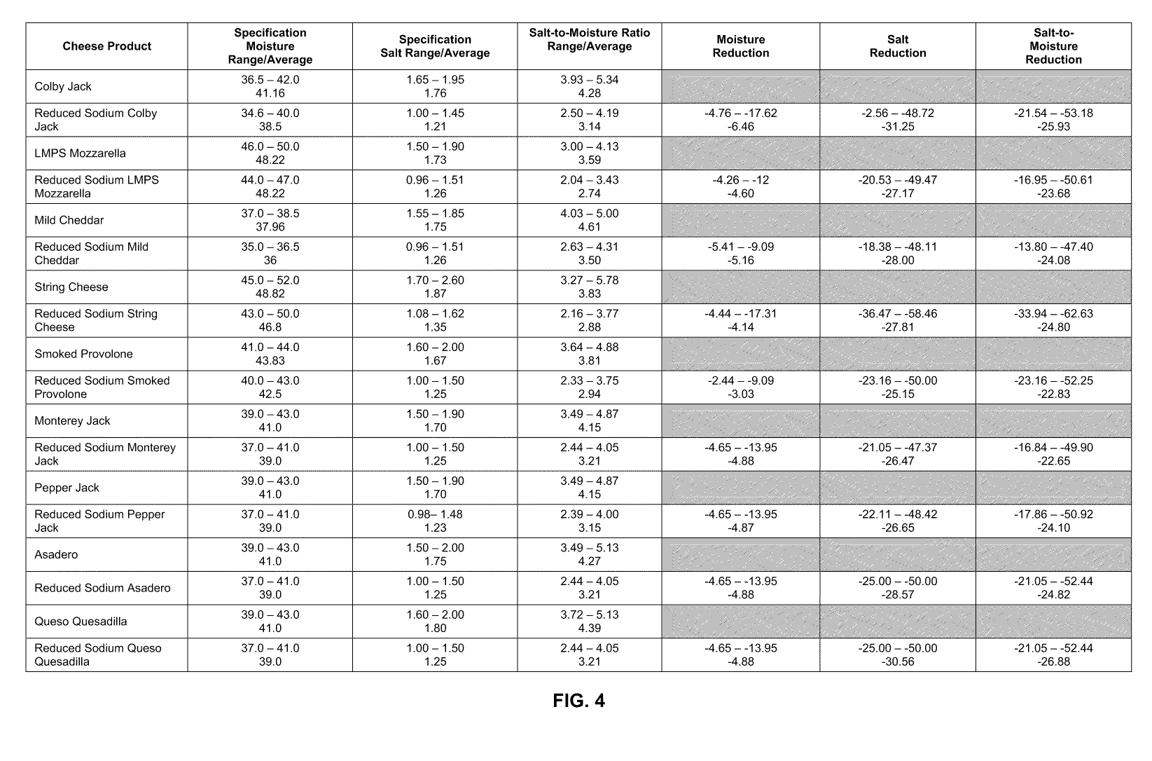

The cheese maker then performs various processes such as cutting 42, cooking 44 and draining the whey 46 to reduce the moisture content of the cheese curd mixture. There are several additional procedures (described below) that can be performed on the cheese curd mixture to reduce the moisture content to a moisture target range, for example a sodium chloride-to-moisture ratio that is at least twenty percent (20%) less than the sodium chloride-to-moisture ratio of a corresponding conventional natural cheese (i.e. mild Cheddar Cheese and several other cheese types listed on FIG. 4), determined by the cheese maker.

One such procedure is the reducing of the cheese curd size by a cutting process 42. The cheese curd, in the cheese vat 38, can be cut by hand or by a mechanical cheese curd cutter. To reduce the curd particle size, a cutting harp has its wires placed closer together. The cutting is a uniform breaking up of the curd mass which is done to facilitate the release of whey that is trapped in the curd mass. In the case of an automated cheese curd cutting system the cutting speed and cutting time can be increased whereby further reduction in curd particle size can be facilitated. The cheese vat can be an open vat or a closed vat as determined by the cheese maker.

Moisture content of the cheese mixture can also be reduced by increasing cook temperature of the cheese curd during a cooking step 44 during the cheese making process. The temperature of the cheese curd mixture can be increased to a predetermined temperature between 100-115 degrees Fahrenheit by a steam jacket associated with the cheese vat 38 or other suitable temperature increasing apparatus. (Different cheeses have different bacterias which have different temperature tolerances.) The increasing of the cooked temperature is governed by the type of fermentation cultures 34 so as not to deactivate the cultures, and rennet enzyme 36 used to make the cheese. The higher the temperature to the maximum temperature allowed would cause more syneresis of the cheese curd mixture to occur. Syneresis is the separation of liquid whey from curd that is caused by contraction of the cheese curd mixture during the cooking 44 procedure of the cheese making process. Such process expels water, i.e. reduces moisture content, from the cheese curd mixture.

An additional procedure that is used to reduce moisture content is to increase stir-out time after the cooking process 44 of the cheese curd mixture. Increased stirring of the cooked cheese curd mixture allows for additional syneresis to occur whereby further reducing the moisture content of the cheese curd mixture.

A further procedure to reduce the moisture content is to increase the rate of acid production in the cheese curd mixture. Increasing the rate of acid production is achieved by using a fast acid producing starter or by using a higher addition rate of the starter. The starter is the fermentation cultures 34 (also referred to as cheese starter culture) mentioned above.

An additional procedure to reduce the moisture content is accomplished by separating the cheese curd mixture from the liquid whey at a higher acidity level. A higher acidity level means that there is a lower pH of the cheese curd mixture. The higher acidity level can be controlled by adding more of the fermentation cultures during the cheese making process.

As one or more of the above mentioned procedures are performed on the cheese curd mixture, the liquid whey is drained from the cheese vat by a whey drainage step 46 resulting in a more dry cheese curd mixture. An additional dry stirring process 50 is typically performed on the cheese curd mixture and additional moisture can be extracted from the cheese curd mixture by increasing the rate of dry stirring 50. Such increased rate of dry stirring 50 can be accomplished manually or by an automated apparatus as determined by the cheese maker.

It should be understood that one or more of the above described procedures can be performed on the cheese curd mixture to deliberately reduce the moisture content of the cheese curd mixture.

As illustrated in FIG. 1, a cheddaring procedure 52 is then performed on the cheese curd mixture. Cheddaring typically includes blocks of curd being positioned on top of each other to expel moisture. The blocks of curd are flipped and rotated periodically as determined by the cheese maker.

As an alternative to dry stirring 50, a matting process 48 well known in the art can be performed on the cheese curd mixture to further reduce the moisture content by separating additional liquid whey from the cheese curd.

A typical follow-up procedure is to take the cheddared curd and subject it to a milling process 66 to grind the curd in preparation for the addition of the sodium chloride 54 to the cheese curd mixture. It should be noted that in some prior art processes for making a reduced salt cheese the salt addition is made to the liquid retentate prior to curd formation. As disclosed above, the subject procedures adds salt (sodium chloride) after curd has been formed in the cheese vat. It should be understood that additional pressure can be applied to the blocks of curd in a pressing step 56, such as by mechanical apparatus, for example a press.

As discussed above, the cheddared curd is milled prior to the addition of the sodium chloride to the cheese curd mixture. As illustrated in FIG. 4 the reduced sodium mild cheddar has a moisture reduction of at least 5.16 percent as compared to the conventional mild cheddar and it also has a sodium chloride reduction of 28 percent compared to the conventional mild cheddar. The resulting sodium chloride to moisture reduction ratio is 24.08 percent and such reduction of moisture and less sodium chloride in the resulting cheese product as compared to a conventional cheese product allows obtaining the highest possible sodium chloride to moisture ratio whereby the produced natural cheese product does not suffer from a bland flavor or reduced shelf life as compared to a conventional cheese product which in the present example is a mild Cheddar Cheese.

FIG. 4 also lists the moisture reduction, percentage of sodium chloride reduction, and resulting sodium chloride-to-moisture reduction ratio of a reduced sodium Asadero and reduced sodium Queso Quesadilla Cheeses compared to conventional like cheeses. The process described herein provides for the highest possible sodium chloride-to-moisture ratio for these natural cheese products without suffering a bland flavor or reduced shelf life as compared to like types of conventional cheese products.

Following the addition of the sodium chloride 54, the cheese curd mixture can be subjected to additional steps such as pressing 56, blocking, storing to age the cheese, packaging 58, and storage 60. The packaging 58 can be for example blocks, slices, or a shredded composition as determined by the cheese maker for wholesale and retail sales. The cheese curd mixture can be stored for a selected period of time to age the cheese (also referred to as ripening of the cheese) prior to final packaging, as determined by the cheese maker.

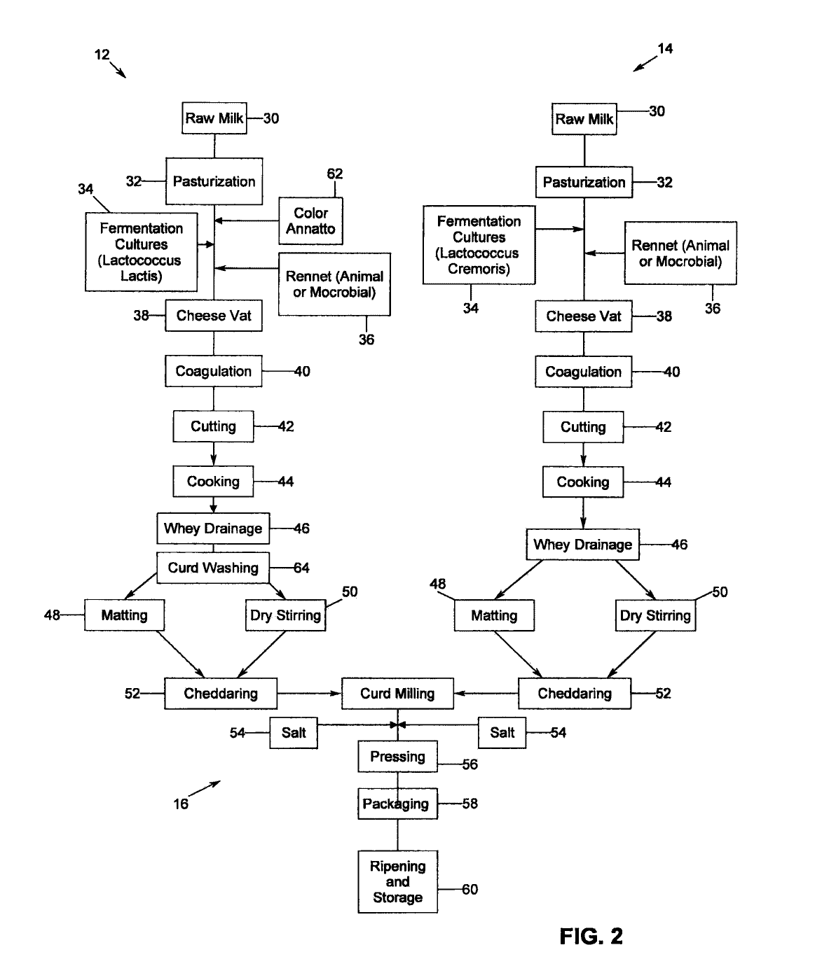

Referring now to FIG. 2, FIG. 2 illustrates a schematic chart portion 16 for an exemplary embodiment for making a reduced sodium Colby-Jack Cheese. As illustrated, in FIG. 2, the left side portion 12 of the schematic chart diagram illustrates production of a Colby Cheese. The right side portion 14 of the schematic chart illustrates the production of a Monterey Jack Cheese. A Pepper Jack Cheese utilizes the same process with the addition of pepper added before the salt additives. The Colby Cheese 12 and the Monterey Jack Cheese are combined to produce a Colby Jack Cheese as illustrated in the schematic chart portion 16 of FIG. 2.

For production of the Colby Cheese shown in the process 12 the steps described above for the Cheddar Cheese shown in the process 10 are similar from the raw milk 30 step through the cheddaring 52 step with the addition of adding color Annatto 62 to the cheese curd mixture prior to addition of the fermentation cultures 34 and the rennet 36 but after the pasteurization step 32. The color Annatto 62 addition will provide a yellow color to the Colby Cheese. Also, during the whey drainage step 46 there is an additional curd washing 64 as part of the whey drainage step.

In reference to the Monterey Jack process 10, the production steps as described above for the Cheddar Cheese process 10 are similar with the exception that no coloring is added to the Monterey Jack cheese curd mixture. Further, in the cooking step 44 the maximum temperature of the curd is slightly lower in Monterey Jack process 14 than the cooking temperature used for the Cheddar Cheese process 10 production. One ordinarily skilled in the art would be aware of the lower maximum temperature of the curd for production of Monterey Jack. Also, for Monterey Jack production the cutting 42 step of the curd results in a larger curd cut than used for production of Cheddar Cheese. The steps of larger curd cut and the lower maximum temperature of the curd results in a higher moisture content in Monterey Jack than in Cheddar Cheese which results is the basic difference between the two cheeses as would be well known by one ordinarily skilled in the art. The Pepper Jack cheese is produced with the same process but pepper is added to the curd either before the salt is added or shortly after the salt is added.

The right side of FIG. 2 illustrates the process 14 for producing Monterey Jack type cheese and for producing Pepper Jack type cheese (with the addition of pepper). The procedures for these types of cheese also include the salt 54, processing 56, packaging 58, and ripening and storage 60 steps but not the mixing of the Colby Cheese illustrated on the left side of FIG. 2.

As illustrated in FIG. 2 both the Colby Cheese and the Monterey Jack Cheese are subjected to the cheddaring process 52 as described above and the resulting curd is milled 66 to mix the Colby 12 and Monterey Jack 14 into a single cheese curd mixture of Colby Jack Cheese 16.

After the milling process 66, sodium chloride is added to the combined Colby and Monterey Jack cheese curd mixture. As illustrated in FIG. 4 the reduced sodium Colby-Jack Cheese has a moisture reduction of 6.46 percent less than the moisture content average for conventional Colby-Jack Cheese. Further, the sodium chloride reduction is 31.25 percent less than the sodium chloride average of conventional Colby-Jack Cheese. The resulting sodium chloride-to-moisture ratio reduction is 25.93 percent less than the sodium chloride-to-moisture ratio average of conventional Colby-jack.

FIG. 4 also lists the moisture reduction, percentage of sodium chloride reduction, and resulting sodium chloride-to-moisture reduction ratio of the reduced sodium Monterey Jack and reduced sodium Pepper Jack cheeses compared to conventional like cheeses. The process described herein provides for the highest possible sodium chloride-to-moisture ratio for these natural cheese products without suffering a bland flavor or reduced shelf life as compared to like types of conventional cheese products.

Following the addition of the sodium chloride to the combined Colby and Monterey Jack cheese curd mixture, the cheese curd is pressed 56 and blocked and packaged 58. The resulting reduced sodium Colby-Jack Cheese 16 can be stored and ripened as determined by the cheese maker. The Colby-Jack Cheese can be packaged in block form, slices, or shredded form again as determined by the cheese maker.

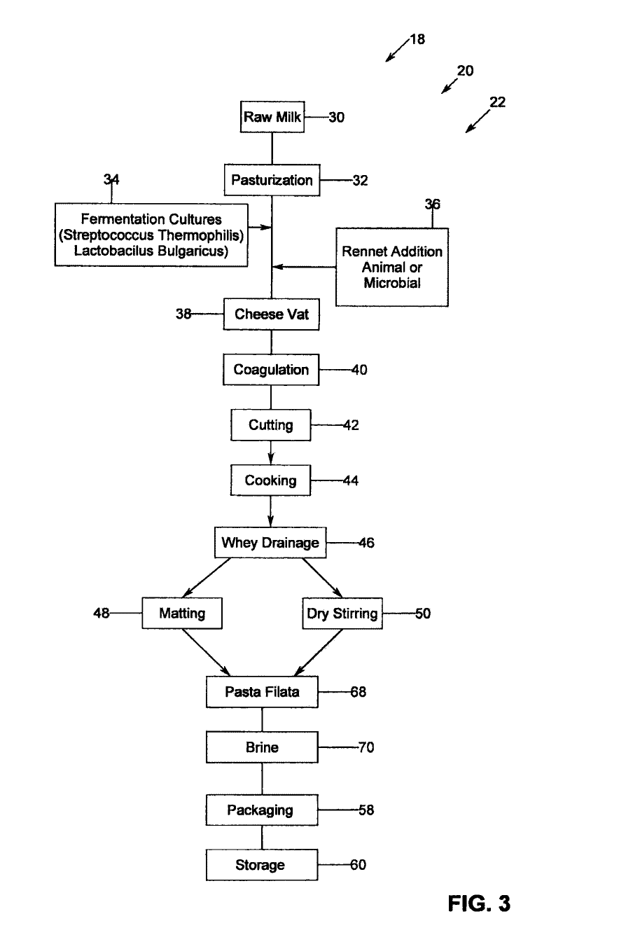

Referring to FIG. 3 there is illustrated a schematic chart for an exemplary embodiment for processes 18, 20, and 22 for making a reduced sodium natural Mozzarella Cheese, a reduced sodium Provolone Cheese, or a String Cheese, respectively. The steps illustrated from the raw milk step 30 through the matting 48 and dry stirring 50 step is similar to the description of production of the Cheddar Cheese as set forth above.

As illustrated in FIG. 3, after the matting 48 or dry stirring 50 step the cheese curd mixture is subjected to a Pasta Filata 68 process which is well known in the art of cheese making. Following the Pasta Filata 68 step the sodium chloride is added to the cheese curd mixture by a soak in a brine solution for a selected period of time and at a selected temperature as determined by the cheese maker. (Alternately, a portion of the sodium chloride can be added prior to the brining step.)

As illustrated in FIG. 4, the sodium chloride reduction for a reduced sodium LMPS Mozzarella Cheese, a reduced sodium String Cheese, and a reduced sodium smoked Provolone Cheese is illustrated. In each exemplary embodiment case the sodium chloride-to-moisture ratio reduction is at least 20 percent less than the sodium chloride-to-moisture ratio average for a conventional Mozzarella, String Cheese or Provolone Cheese. Specifically, the sodium chloride-to-moisture ratio reduction for the reduced sodium LMPS Mozzarella Cheese is 23.68 percent less than conventional Mozzarella; the sodium chloride-to-moisture ratio reduction for reduced sodium String Cheese is 24.8 percent less than the sodium chloride-to-moisture ratio average of conventional String Cheese; and the sodium chloride-to-moisture ratio reduction for reduced sodium smoked Provolone is 22.83 percent less than the sodium chloride-to-moisture ratio average for conventional smoked Provolone.

After the brine soak 70 step the cheese curd moisture for Mozzarella Cheese, Provolone Cheese, and String Cheese are packaged 58 and stored 60 as determined by the cheese maker.

For purposes of the present application, the moisture content test of the respective cheese curd mixtures is based on standard methods for examination of dairy products (SMEDDP) vacuum oven. The sodium chloride test is based on the standard methods for examination of dairy products (SMEDDP) coulometric titration.

It should be understood that the specific moisture reduction, sodium chloride reduction, and sodium chloride-to-moisture ratio reduction may vary because of the time of year or the type of milk being used by the cheese maker for any specific batch of cheese. It is believed by the Applicant that the reduced sodium natural cheese product will have a sodium chloride content that is no more than 75 percent of the conventional sodium chloride content of a corresponding conventional natural cheese and that the reduced sodium natural cheese product produced as disclosed in the present application will have a sodium chloride-to-moisture ratio that is at least about 20 percent less than the sodium chloride-to-moisture ratio of a corresponding conventional natural cheese. The moisture content of the cheese curd for the particular type of cheese being produced is reduced at least by one or more procedures of a group of procedures described and listed above. As determined by the cheese maker, one or any combination of two or more of the procedures can be used to reduce the moisture content of a particular cheese being manufactured.

In addition to the reduced sodium natural cheese types described above, the methods and processes described in this disclosure can be used to produce reduced sodium natural cheese typically referred to as “American Style Cheeses,” for example but not limited to Monterey Jack, Pepper Jack, Asadero, Queso Quesadilla, etc. (See FIG. 4)

Although the foregoing description of the present product and method has been shown and described with reference to particular embodiments and applications thereof, it has been presented for purposes of illustration and description and is not intended to be exhaustive or to limit the disclosure to the particular embodiments and applications disclosed. It will be apparent to those having ordinary skill in the art that a number of changes, modifications, variations, additions, or alterations to the product and method as described herein may be made, none of which depart from the spirit or scope of the present disclosure. The particular embodiments and applications were chosen and described to provide the best illustration of the principles of the disclosure and its practical application to thereby enable one of ordinary skill in the art to utilize the disclosure in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

What is claimed is:

1. A method for manufacturing a natural cheese having at least twenty-five percent less sodium chloride than a corresponding conventional natural cheese having a conventional moisture content, a conventional sodium chloride content, and a conventional sodium chloride-to-moisture ratio, the method comprising:
providing a cheese milk mixture including a quantity of raw milk and a quantity of fermentation cultures;
adding rennet to the cheese milk mixture to thereby produce a cheese curd mixture;
adding a reduced amount of sodium chloride to the cheese curd mixture; and
processing the cheese curd mixture to produce a natural cheese product while simultaneously reducing the moisture content of the cheese curd mixture such that the natural cheese product has a sodium chloride content that is no more than about seventy-five percent of the conventional sodium chloride content of a corresponding conventional natural cheese and such that the natural cheese product has a sodium chloride-to-moisture ratio that is at least about twenty percent less than the sodium chloride-to-moisture ratio of a corresponding conventional natural cheese, wherein the moisture content of the cheese curd is reduced by at least one of the group of procedures consisting of:
reducing the cheese curd particle size;
increasing the cook temperature of the cheese curd;
increasing the stir-out time after cooking the cheese curd mixture;
increasing the rate of acid production;
separating the cheese curd from whey at a higher acidity level;
increasing the rate of dry stirring of the cheese curd prior to the addition of sodium chloride; and
any combination of two or more of these procedures.

2. The method of claim 1, further comprising:
during said processing step, reducing the moisture content of the cheese curd mixture such that the natural cheese product has a moisture content that is at least about two percent less than the moisture content of a corresponding conventional natural cheese.

3. The method of claim 1, further comprising the step of forming the cheese curd mixture into a predetermined product shape.

4. The method of claim 3, further comprising the step of packaging the predetermined product shape in selected quantities.

5. The method of claim 1, wherein the cook temperature of the cheese curd is less than the temperature that will deactivate the fermentation cultures.

6. The method of claim 1, further comprising the step of cheddaring the cheese curd mixture.

7. The method of claim 6, wherein the cheese curd mixture comprises one of a Cheddar Cheese, a Colby Cheese, a Colby Jack Cheese, a Monterey Jack cheese, a Pepper Jack cheese, an Asadero Cheese, and a Queso Quesadilla Cheese.

8. The method of claim 1, further comprising the step of performing pasta filata, wherein the step of adding an amount of sodium chloride is performed by immersing the cheese curd mixture in a brine solution at a predetermined temperature after performing pasta filata.

9. The method of claim 8, wherein the cheese curd mixture comprises one of a Mozzarella, a Provolone, and a String Cheese.

10. The method of claim 1, further comprising the step of aging the cheese curd mixture a predetermined time before packaging the cheese curd mixture.

11. The method of claim 1, further comprising the step of pasteurizing the raw milk before combining with the fermentation cultures and adding the rennet.

12. A reduced sodium natural cheese product made by the process of claim 1.

13. A method for manufacturing a reduced sodium natural cheese comprising:
combining, as a cheese milk mixture, a quantity of raw milk and cheese starter cultures;
adding rennet to the cheese milk mixture to thereby produce a cheese curd mixture;
adding a reduced amount of sodium chloride to the cheese curd mixture; and
reducing the moisture content of the cheese curd mixture below a selected level to produce a natural cheese product having a sodium chloride-to-moisture ratio that is at least about twenty percent less than the sodium chloride-to-moisture ratio of a corresponding conventional natural cheese by one or more processes selected from the group consisting of: reducing the cheese curd particle size, increasing the cook temperature of the cheese curd, increasing the stir-out time after cooking the cheese curd mixture, increasing the rate of acid production, separating the cheese curd from whey at a higher acidity level, increasing the rate of dry stirring of the cheese curd.

14. The method of claim 13, further comprising:
during said reducing step, reducing the moisture content of the cheese curd mixture such that the natural cheese product has a moisture content that is at least about two percent less than the moisture content of a corresponding conventional natural cheese.

15. The method of claim 13, wherein the cook temperature of the cheese curd mixture includes a temperature that does not exceed the temperature that will deactivate the cheese starter cultures.

16. The process for manufacturing a reduced sodium chloride natural cheese of claim 13, including forming the cheese curd mixture into a predetermined product shape.

17. The method of claim 16, including packaging the predetermined product type in selected quantities.

18. The method of claim 13, including the step of cheddaring the cheese curd mixture.

19. The method of claim 18, wherein the cheese curd mixture is one of a Cheddar Cheese, a Colby Cheese, a Colby Jack Cheese, a Monterey Jack Cheese, a Pepper Jack cheese, an Asadero Cheese, and a Queso Quesadilla Cheese.

20. The method of claim 13, including a step of performing pasta filata and the step of adding an amount of sodium chloride is by immersing the cheese curd mixture in a brine solution at a predetermined temperature and time period after performing pasta filata.

21. The method of claim 20, wherein the cheese curd mixture is one of a Mozzarella, a Provolone, and a String Cheese.

22. The method of claim 13, including the step of aging the cheese curd mixture a predetermined time before packaging the cheese curd mixture.

23. The method of claim 13, including pasteurizing the raw milk before combining with the fermentation cultures and adding rennet.

24. The product made by the process of claim 13.

25. A reduced sodium natural cheese product comprising:
a mixture of raw milk and cheese starter cultures;
a quantity of rennet; and
a predetermined amount of sodium chloride and a reduced moisture content, wherein said reduced sodium natural cheese product has a sodium chloride-to-moisture ratio that is at least about twenty percent less than the sodium chloride-to-moisture ratio of a corresponding conventional natural cheese.

26. The reduced sodium natural cheese product of claim 25, wherein the moisture content of the reduced sodium natural cheese product is at least about two percent less than the moisture content of a corresponding conventional natural cheese.

27. The natural cheese product of claim 25, wherein the natural cheese product can be heated up to a predetermined temperature that does not exceed a temperature that will deactivate the cheese starter culture.

28. The natural cheese product of claim 25, wherein the cheese product is cheddared.

29. The natural cheese product of claim 28, wherein the cheese curd mixture is one of a Cheddar Cheese, a Colby Cheese, a Colby Jack Cheese, a Monterey Jack Cheese, a Pepper Jack Cheese, an Asadero Cheese, and a Queso Quesadilla Cheese.

30. The natural cheese product of claim 25, wherein the cheese product is subject to a pasta filata procedure.

31. The natural cheese product of claim 30, wherein the cheese curd mixture is one of a Mozzarella, a Provolone, and a String Cheese.

32. The natural cheese product of claim 25, wherein the cheese product is aged a predetermined time period.

33. The natural cheese product of claim 25, wherein the cheese product is configured in predetermined packaged quantities.
